(19) United States
(12) Patent Application Publication
(10) Pub. No.: US 2011/0045988 A1
(43) Pub. Date: Feb. 24, 2011

(54) HIGH-TEMPERATURE SUPERCONDUCTING RIBBON CONDUCTOR COMPOSITE PROVIDED WITH A COOLING LAYER

(75) Inventors: Christian Schacherer, Niederrohrdorf (CH); Michael Schwarz, Edingen-Neckarhausen (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: KARLSRUHER INSTITUT FUER TECHNOLOGIE, Karlsruhe (DE)

(21) Appl. No.: 12/809,133

(22) PCT Filed: Nov. 13, 2008
(86) PCT No.: PCT/EP2008/009571

§ 371 Date: Nov. 2, 2010

(30) Foreign Application Priority Data
Dec. 20, 2007 (DE) 10 2007 061 891.5

(51) Int. Cl. H01B 12/00

(52) U.S. Cl. 505/237; 174/125.1

(57) ABSTRACT

A high-temperature superconducting ribbon conductor composite device includes a high-temperature superconducting ribbon conducing composite including a substrate ribbon, at least one buffer layer disposed above the substrate ribbon, an HTSL layer disposed above the at least one buffer layer, and a cover. A cooling layer is disposed on the high-temperature superconducting ribbon conductor composite and includes at least one of a metal and a partly conductive or non-conductive oxide layer of at least one of an alkali, an alkaline earth and a rare earth element. The cooling layer has a thickness of 20 μm to 200 μm.

### CROSS REFERENCE TO PRIOR APPLICATIONS

This application is a U.S. National Phase application under 35 U.S.C. § 371 of International Application No. PCT/EP2008/009571, filed on Nov. 13, 2008 and which claims benefit to German Patent Application No. 10 2007 061 891.5, filed on Dec. 20, 2007. The International Application was published in German on Jul. 2, 2009 as WO 2009/080156 A1 under PCT Article 21(2).

### FIELD

The present invention relates to a superconducting ribbon conductor composite provided with a cooling layer, comprising a substrate ribbon, a buffer layer on top of that, an HTSL layer on top of that, and a cover layer, and it belongs to the realm of superconducting current limiters in electric power technology.

### BACKGROUND

To date, mainly the substrate, for example, the support ribbon, of a superconducting ribbon conductor has been used as a cold reservoir. The approaches taken for power consumption to date lower the electric resistance of the ribbon conductor, as a result of which it becomes unappealing or even ineffective for use in superconducting current limiter technology.

### SUMMARY

An aspect of the present invention is to lower the temperature after a certain period of time in the live, normal-conducting state in order to reduce or avoid damage to the HTSL layer or in order to reduce or prevent the melting of ribbon conductors for which a low-melting solder is used.

In an embodiment, the present invention provides high-temperature superconducting ribbon conductor composite device which includes a high-temperature superconducting ribbon conducing composite including a substrate ribbon, at least one buffer layer disposed above the substrate ribbon, an HTSL layer disposed above the at least one buffer layer, and a cover. A cooling layer is disposed on the high-temperature superconducting ribbon conductor composite and includes at least one of a metal and a partly conductive or non-conductive oxide layer of at least one of an alkali, an alkaline earth and a rare earth element. The cooling layer has a thickness of 20 μm to 200 μm.

### BRIEF DESCRIPTION OF THE DRAWING

The present invention is described in greater detail below on the basis of embodiments and of the drawing in which:

FIG. 1 shows a piece of the ribbon conductor.

### DETAILED DESCRIPTION

The cooling layer is a metal layer or an oxide layer that is hardly or not at all conductive and that consists of alkalis, alkaline earths and rare earths as well as their compounds or ceramic materials. The cooling layer has a thickness of 20 μm to about 200 μm. The coating is a cooling layer that is hardly or not at all electrically conductive and that has a good thermal conductivity and thermal capacity. The cooling layers are thus metal oxides or else alloyed and non-alloyed metals or ceramic materials.

The thin, hardly or not at all electrically conductive oxide layer is applied as the cooling layer onto the ribbon conductor. The oxide layer can be applied partially onto the ribbon conductor or it can completely surround the ribbon conductor. By increasing the mass of the ribbon conductor, the absolute thermal capacity is raised, thus lowering the maximum temperature reached in the ribbon conductor or in the superconducting layer during a quench (transition to normal conduction). Moreover, in the recooling phase, the rough and thus enlarged surface area of the cooling layer ensures a greater cooling capacity of the surrounding liquid nitrogen, as a result of which the recooling time is shortened.

The additional layer does not impair the electric properties of the ribbon conductor during normal operation of the superconducting current transport. The ribbon conductor is not damaged by the application.

The special effect is, on the one hand, that the temperature in the superconductor can be kept low during the limiting procedure, and on the other hand, the recooling time is shortened by the layer itself after the limiting procedure. This is due to the good thermal conductivity and the slight layer thickness, along with the large and rough surface area in contact with the coolant LN₂. The layer additionally fulfills the function of an electric insulation layer and replaces interlaid insulation films that make poor contact with the ribbon conductor.

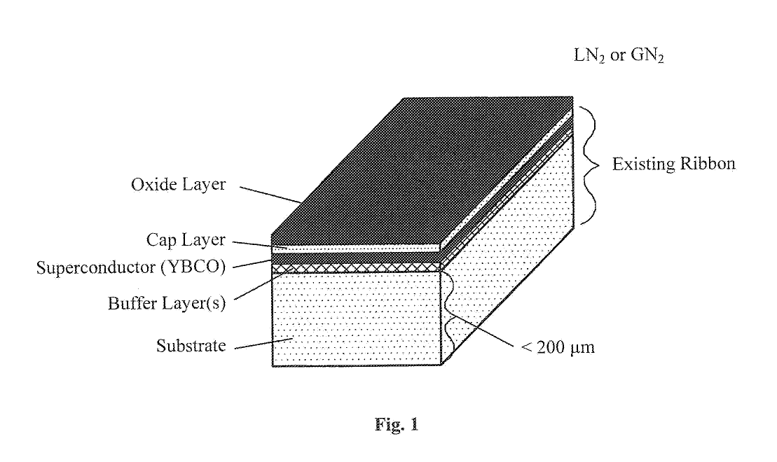

A piece of the ribbon conductor is shown in the single FIG. 1. FIG. 1 shows a section of the ribbon conductor that is covered with an oxide layer as the cooling layer. The layer thickness ratios and the other geometrical dimensions are not drawn to scale. The sectional drawing is intended merely to indicate the sequence of the layers. The substrate is directly covered by the buffer layer or layers, which can be an oxide layer or various oxide layers. This is followed by the superconductor, here, for example, YBCO. This superconductor layer is followed by the cap layer. The available superconductor ribbon is present up to that point. This ribbon is now covered with the oxide layer as the cooling layer. In order to give an impression of the dimensions, the dimension pertaining to the substrate thickness is given here: it amounts to up to 200 μm. Such a superconductor ribbon is cooled by liquid nitrogen, LN₂, or by gaseous nitrogen, GN₂, depending on the transition temperature.

When a durable coating is applied, the different coefficients of expansion of the cooling layer and of the ribbon conductor pose a technical challenge. When a metal is applied, for example, aluminum, a very durable bond is formed with the ribbon conductor. This additionally applied metal is subsequently oxidized. The aluminum layer is stably and firmly joined to the residual aluminum which, in turn, has a firm metallic bond with the ribbon conductor.

The ribbon conductor thus structured increases the possible switching energy in current limiters that consist of such superconducting ribbon conductors—called coated conductors or 2G wires in technical terminology. The high electric resistance of the additional layer does not cause an increase in the limited short-circuit current.

The present invention is not limited to embodiments described herein; reference should be had to the appended claims.

1-3. (canceled)

4. A high-temperature superconducting ribbon conductor composite device, comprising:
a high-temperature superconducting ribbon conducing composite including a substrate ribbon, at least one buffer layer disposed above the substrate ribbon, an HTSL layer disposed above the at least one buffer layer, and a cover; and
a cooling layer disposed on the high-temperature superconducting ribbon conductor composite and including at least one of a metal and a partly conductive or non-conductive oxide layer of at least one of an alkali, an alkaline earth and a rare earth element, the cooling layer having a thickness of 20 μm to 200 μm.

5. The high-temperature superconducting ribbon conductor composite device as recited in claim 4, wherein the cooling layer is an oxide ceramic.

6. The high-temperature superconducting ribbon conductor composite device as recited in claim 4, wherein the cooling layer completely covers the high-temperature superconducting ribbon conductor composite over a length thereof and around at least a portion of a circumference thereof, and at least partially covers the cover layer over a width thereof, and is exposed to surroundings of the device.

7. The high-temperature superconducting ribbon conductor composite device as recited in claim 6, wherein the cooling layer is an oxide ceramic.

8. The high-temperature superconducting ribbon conductor composite device as recited in claim 4, wherein the cooling layer completely surrounds the high-temperature superconducting ribbon conductor composite.
